(19) United States
(12) Patent Application Publication
(10) Pub. No.: US 2015/0062302 A1
(43) Pub. Date: Mar. 5, 2015

(54) MEASUREMENT DEVICE, MEASUREMENT METHOD, AND COMPUTER PROGRAM PRODUCT

(71) Applicant: KABUSHIKI KAISHA TOSHIBA, Tokyo (JP)

(72) Inventors: Hideaki Uchiyama, Kawasaki (JP); Yuta Itoh, Kawasaki (JP); Akihito Seki, Yokohama (JP); Ryuzo Okada, Kawasaki (JP)

(21) Appl. No.: 14/471,028

(22) Filed: Aug. 28, 2014

(30) Foreign Application Priority Data
Sep. 3, 2013 (JP) 2013-182511

(51) Int. Cl. G01B 11/14; H04N 13/00

(52) U.S. Cl. CPC G01B 11/14; H04N 13/0022
USPC 348/46

(57) ABSTRACT

According to an embodiment, a measurement device includes a first calculator, a second calculator, and a determination unit. The first calculator is configured to calculate, by using images of an object from viewpoints, first confidence for each of a plurality of first three-dimensional points in three-dimensional space, the first confidence indicating likelihood that the first three-dimensional point is a point on the object. The second calculator is configured to calculate, by using distance information indicating a measurement result of a distance from a measurement position to a measured point on the object, second confidence for each of a plurality of second three-dimensional points in the three-dimensional space, the second confidence indicating likelihood that the second three-dimensional point is a point on the object. The determination unit is configured to determine a three-dimensional point on the object by using the first confidence and the second confidence.

### CROSS-REFERENCE TO RELATED APPLICATION

This application is based upon and claims the benefit of priority from Japanese Patent Application No. 2013-182511, filed on Sep. 3, 2013; the entire contents of which are incorporated herein by reference.

### FIELD

Embodiments described herein relate generally to a measurement device, a measurement method, and a computer program product.

### BACKGROUND

A conventional technology for performing three-dimensional measurement of an object using a plurality of images of the object captured from a plurality of viewpoints is known. In this technology, three-dimensional measurement is performed by calculating confidence for each of three-dimensional points in three-dimensional space indicating likelihood that the three-dimensional point is a point on the object on the basis of similarity between the images, and determining a three-dimensional point having a higher confidence to be a point on the object.

In the conventional technology described above, confidence for each three-dimensional point is calculated by using images. This may cause decrease in accuracy of the confidence for three-dimensional points depending on the texture of the object, leading to decrease in accuracy of three-dimensional measurement.

### BRIEF DESCRIPTION OF THE DRAWINGS

FIG. 1 is a configuration diagram illustrating an example of a measurement device according to a first embodiment;

FIG. 2 is a diagram illustrating an example of an image-capturing and measurement method according to the first embodiment;

FIG. 3 is a diagram illustrating an example of the multiple-baseline stereo method according to the first embodiment;

FIG. 4 is a diagram illustrating an example of a method for calculating second confidence according to the first embodiment;

FIG. 5 is a flowchart illustrating an example of processing according to the first embodiment;

FIG. 6 is a configuration diagram illustrating an example of a measurement device according to a second embodiment;

FIG. 7 is a diagram illustrating an example of a method for calculating second confidence according to the second embodiment;

FIG. 8 is a flowchart illustrating an example of processing according to the second embodiment;

FIG. 9 is a diagram illustrating an example of an image-capturing and measurement method according to a first modification;

FIG. 10 is a diagram illustrating another example of the image-capturing and measurement method according to the first modification;

FIG. 11 is a diagram illustrating an example of an image-capturing and measurement method according to a second modification;

FIG. 12 is a configuration diagram illustrating an example of an image-capturing unit according to the second modification; and

FIG. 13 is a diagram illustrating an example of a hardware configuration of the measurement device according to the first and the second embodiments and the first and the second modifications.

### DETAILED DESCRIPTION

According to an embodiment, a measurement device includes an acquisition unit, a first calculator, a second calculator, and a determination unit. The acquisition unit is configured to acquire a plurality of images of an object from a plurality of viewpoints, and distance information indicating a measurement result of a distance from a measurement position to a measured point on the object. The first calculator is configured to calculate, by using the images, first confidence for each of a plurality of first three-dimensional points in three-dimensional space, the first confidence indicating likelihood that the first three-dimensional point is a point on the object. The second calculator is configured to calculate, by using the distance information, second confidence for each of a plurality of second three-dimensional points in the three-dimensional space, the second confidence indicating likelihood that the second three-dimensional point is a point on the object. The determination unit is configured to determine a three-dimensional point on the object by using the first confidence and the second confidence.

Embodiments are described in detail with reference to the accompanying drawings.

### First Embodiment

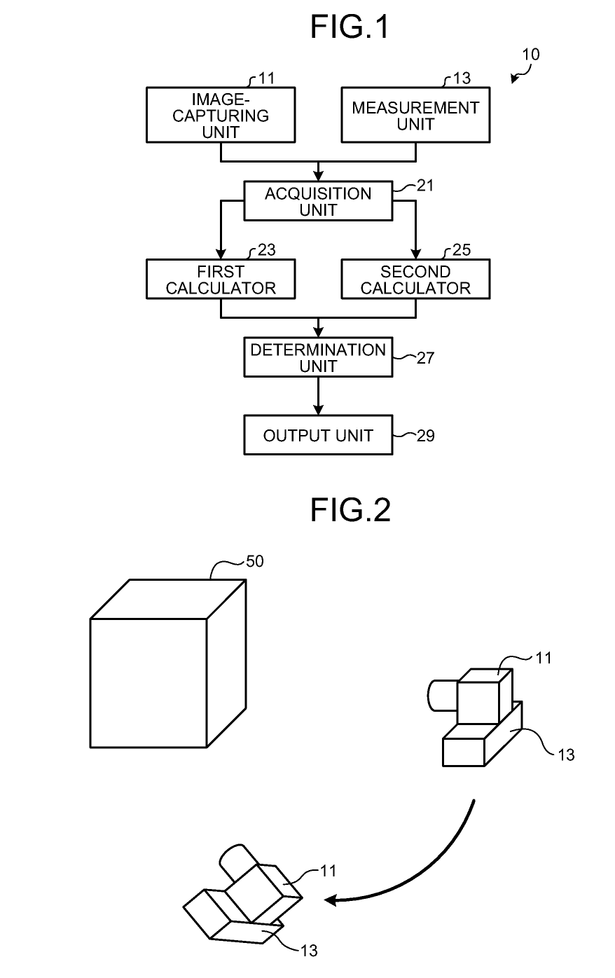

FIG. 1 is a configuration diagram illustrating an example of a measurement device 10 according to a first embodiment. As illustrated in FIG. 1, the measurement device 10 includes an image-capturing unit 11, a measurement unit 13, an acquisition unit 21, a first calculator 23, a second calculator 25, a determination unit 27, and an output unit 29.

The image-capturing unit 11 can be implemented by an image-capturing device such as a visible camera, an infra-red camera, a multi-spectral camera, and a compound-eye camera including a microlens array. Although, in the first embodiment, the image-capturing unit 11 is implemented, for example, by a visible camera, the embodiment is not limited to this.

The measurement unit 13 can be implemented by a distance sensor, such as a laser sensor, an ultrasound sensor, and a millimeter-wave sensor, that is capable of measuring a distance to an object. Although, in the first embodiment, the measurement unit 13 is implemented, for example, by a laser sensor using the time-of-flight method in which a distance to an object is measured on the basis of velocity of light and a time period from when a light beam is emitted from a light source to when a reflection of the light beam reflected off the object reaches the sensor, the embodiment is not limited to this.

The acquisition unit 21, the first calculator 23, the second calculator 25, and the determination unit 27 may be implemented by causing a processing device such as a central processing unit (CPU) to execute a computer program, that is, implemented by software, may be implemented by hardware such as an integrated circuit (IC), or may be implemented by both software and hardware.

The output unit 29 may be implemented by a display device for display output such as a liquid crystal display or a touchscreen display, may be implemented by a printing device for print output such as a printer, or may be implemented by using both devices.

The image-capturing unit 11 captures an object from a plurality of viewpoints to obtain a plurality of images. The measurement unit 13 measures a distance from a measurement position to a measured point on the object to obtain distance information indicating a measurement result. Although, in the first embodiment, the distance information includes accuracy of measurement of the laser sensor, reflection intensity of laser (an example of light), and a distance to a measured point on the object, the embodiment is not limited to this. For example, accuracy of measurement of a laser sensor is generally described in a specification of the laser sensor, thus the distance information may exclude the accuracy of measurement of the laser sensor.

In the first embodiment, it is assumed that calibration has already been performed to match a coordinate system of the image-capturing unit 11 and that of the measurement unit 13. In order to match the coordinate system of the image-capturing unit 11 and that of the measurement unit 13 by calibration, the measurement device 10 may employ a method in which a planar checkerboard pattern is captured by the image-capturing unit 11 and measured by the measurement unit 13. The method is disclosed, for example, in Qilong Zhang and Robert Pless, “Extrinsic calibration of a camera and laser range finder (improves camera calibration),” IEEE/RSJ International Conference on Intelligent Robots and Systems, pp. 2301-2306, 2004.

FIG. 2 is a diagram illustrating an example of an image-capturing and measurement method according to the first embodiment. In the example illustrated in FIG. 2, the image-capturing unit 11 and the measurement unit 13 are attached to each other, and a measurer captures images of an object 50 with the image-capturing unit 11 and measures the object 50 with the measurement unit 13 while moving around the object 50. In the image-capturing and measurement method, accuracy of measurement increases as the measurer moves in a wider range around the object 50.

The image-capturing unit 11 captures the object from a plurality of different positions (viewpoints) to obtain a plurality of (time-series) images. The measurement unit 13 measures a distance to the object from each of the positions (measurement position) at which the image-capturing unit 11 captures the object 50 to obtain a plurality of pieces of distance information. In other words, in the image-capturing and measurement method according to the first embodiment, the measurement device 10 obtains time-series images captured from a plurality of different viewpoints, and distance information measured at the same viewpoints as the viewpoints at which images constituting the time-series images are captured.

The image-capturing unit 11 and the measurement unit 13 may or may not be detachably attached.

The acquisition unit 21 acquires a plurality of images of an object captured from a plurality of viewpoints, and distance information indicating a measurement result of a distance from a measurement position to a measured point on the object. In the first embodiment, the acquisition unit 21 acquires time-series images captured by the image-capturing unit 11 from a plurality of different viewpoints, and a plurality of pieces of distance information measured by the measurement unit 13 at the same viewpoints as the viewpoints at which images constituting the time-series images are captured.

The acquisition unit 21 performs calibration so that the coordinate systems of the acquired images match. In the first embodiment, the acquisition unit 21 performs calibration to match the coordinate systems of the respective images constituting the time-series images captured from a plurality of different viewpoints.

On performing calibration to match the coordinate systems of the respective images constituting the time-series images captured from a plurality of different viewpoints, the measurement device 10 may use a method such as “structure from motion” described in Richard Hartley and Andrew Zisserman, “Multiple View Geometry in Computer Vision,” Cambridge University Press, 2003 in which calibration is performed on all the images captured from different viewpoints by batch processing. The measurement device 10 may also use a method such as “Simultaneous localization and mapping” disclosed in Andrew J. Davison, Ian Reid, Nicholas Molton and Olivier Stasse, “MonoSLAM: Real-Time Single Camera SLAM,” IEEE Transactions on Pattern Analysis and Machine Intelligence, volume 29, issue 6, pp. 1052-1067, 2007 in which calibration is performed on time-series images by sequential processing.

The first calculator 23 calculates first confidence for each of a plurality of first three-dimensional points in three-dimensional space indicating likelihood that the first three-dimensional point is a point on the object by using a plurality of images acquired by the acquisition unit 21.

The first calculator 23 calculates the first confidence by using, for example, the multiple-baseline stereo method. Specifically, the first calculator 23 calculates a plurality of first three-dimensional points by using a first two-dimensional point on a reference image among a plurality of images, projects the first three-dimensional points on an image among the images other than the reference image to calculate a plurality of second two-dimensional points on the image, and calculates the first confidence for each of the first three-dimensional points on the basis of similarity between a pixel value of the first two-dimensional point and a pixel value of each of the second two-dimensional points. The multiple-baseline stereo method is disclosed in, for example, M. Okutomi and T. Kanade, “A multiple-baseline stereo,” IEEE Transactions on Pattern Analysis and Machine Intelligence, Volume 15 Issue 4, pp. 353-363, April 1993.

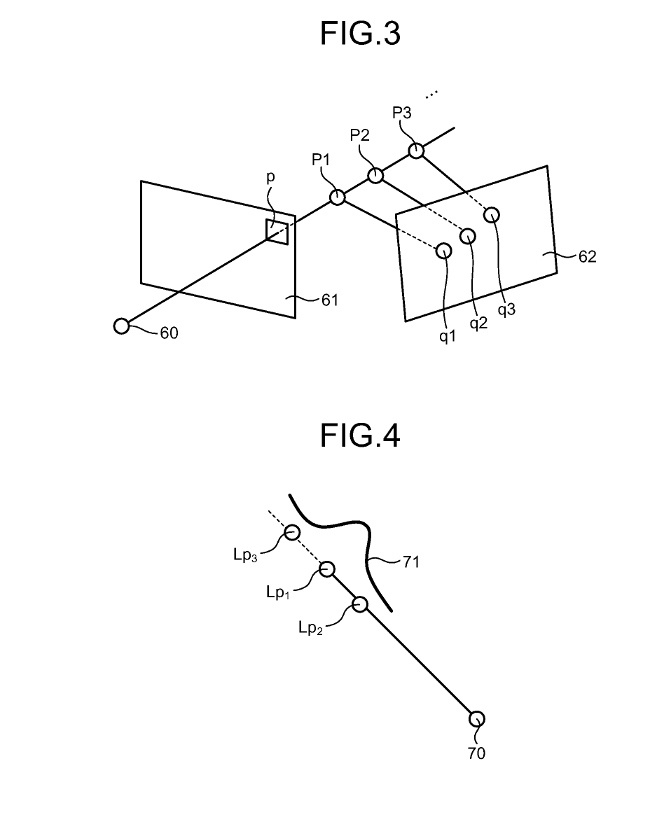

FIG. 3 is a diagram illustrating an example of the multiple-baseline stereo method according to the first embodiment.

First, the first calculator 23 selects a reference image 61 from the time-series images acquired by the acquisition unit 21, and selects an image 62 that was captured right after the reference image 61 in time-series order. This is because much of a captured region in the image 62 overlaps a captured region in the reference image 61. The description above, however, is illustrative and not limiting. The first calculator 23 may select any image as long as the image was captured from a viewpoint different from the viewpoint from which the reference image 61 was captured, and has a captured region overlapping with a captured region in the reference image 61. The first calculator 23 may select two or a larger number of images.

Next, the first calculator 23 sets a line passing through a pixel p (an example of the first two-dimensional point) on the reference image 61 and a camera center 60 of the image-capturing unit 11, and disposes three-dimensional points P1 to P3 (an example of a plurality of first three-dimensional points) on the set line. The three-dimensional points P1 to P3 may be disposed at regular intervals, or may be disposed in accordance with distances, but the embodiment is not limited to this. The three-dimensional points P1 to P3 may be disposed in any method. The number of the three-dimensional points P1 to P3 disposed on the line may be any number as long as it is a plural number.

The first calculator 23 then projects the three-dimensional points P1 to P3 on the image 62 to acquire corresponding points (pixels) q1 to q3 (an example of a plurality of second two-dimensional points) on the image 62.

The first calculator 23 calculates similarity between a pixel value of the pixel p and a pixel value of each of the corresponding points q1 to q3, and calculates, on the basis of the calculated similarity, first confidence for each of the three-dimensional points P1 to P3. Specifically, the first calculator 23 calculates the first confidence for a three-dimensional point P such that as the similarity between a pixel value of a pixel p and a pixel value of a corresponding point q increases, that is, as both pixel values become closer, the first confidence for the three-dimensional point P increases. Examples of the pixel value include a luminance value, but the embodiment is not limited to this.

The second calculator 25 calculates second confidence for each of a plurality of second three-dimensional points in three-dimensional space indicating likelihood that the second three-dimensional point is a point on the object by using the distance information acquired by the acquisition unit 21.

Specifically, the second calculator 25 calculates a measured point on the object on the basis of a distance contained in the distance information, sets a plurality of second three-dimensional points on a line passing through the calculated measured point and a measurement position, and calculates second confidence for each of the second three-dimensional points.

The second calculator 25 calculates second confidence for a second three-dimensional point such that as the distance between the second three-dimensional point and the measured point decreases, the second confidence for the second three-dimensional point increases. The second calculator 25 calculates second confidence for second three-dimensional points adjacent to each other such that as the distance to the measured point decreases and as accuracy of measurement of the laser sensor contained in the distance information increases, the difference in the second confidence between second three-dimensional points adjacent to each other increases. Consequently, the second confidence of a plurality of second three-dimensional points represents a normal distribution with the measured point being the center. The second calculator 25 calculates the second confidence such that as the reflection intensity contained in the distance information increases, the second confidence increases.

FIG. 4 is a diagram illustrating an example of a method for calculating the second confidence according to the first embodiment.

First, it is assumed that the measurement unit 13 has measured an object from the center 70 of the measurement unit 13 (the center of the distance sensor), which is a measurement position, and acquired a measured point Lp₁.

The second calculator 25 sets a line passing through the center 70 of the distance sensor and the measured point Lp₁ to dispose three-dimensional points Lp₁ to Lp₃ (an example of a plurality of second three-dimensional points) on the set line, where the three-dimensional point Lp₁ is the measured point Lp₁. The three-dimensional points Lp₁ to Lp₃ may be disposed, for example, at regular intervals, or may be disposed in accordance with distances, but the embodiment is not limited to this. The three-dimensional points Lp₁ to Lp₃ may be disposed in any method. The number of the three-dimensional points Lp₁ to Lp₃ disposed on the line may be any number as long as it is a plural number.

Supposing that three-dimensional points on the line are represented by a variable X, and the second confidence for each of the three-dimensional points on the line is represented by F(X), F(X) is expressed by Equation (1) using a normal distribution, where Lₚ represents its mean, and σ represents its deviation.

$$F ( X ) = a \frac{1}{\sqrt{2 π {σ}^{2}}} exp ( \frac{{( X - {L}_{p} )}^{2}}{2 {σ}^{2}} ) \qquad ( 1 )$$

where σ is calculated from a width of the accuracy of measurement of the laser sensor. For example, supposing that a width of the accuracy of measurement of the laser sensor is W₁, σ can be W₁.

As accuracy of measurement of the laser sensor increases and as a distance to the measured point decreases, the difference in second confidence between second three-dimensional points adjacent to each other increases. Consequently, the second confidence for the second three-dimensional points Lp₁ to Lp₃ represents a normal distribution 71 with the three-dimensional point Lp₁ (measured point Lp₁) being the center.

In Equation (1), a represents a variable for adjusting the value of the second confidence, and is calculated from the reflectance (reflection intensity) of laser. For example, supposing that the reflectance of the laser is R, a can be R.

Consequently, the second confidence increases as the reflectance increases.

The determination unit 27 determines a three-dimensional point on the object by using the first confidence calculated by the first calculator 23 and the second confidence calculated by the second calculator 25.

Specifically, the determination unit 27 calculates an integrated confidence by adding or multiplying the first confidence for a first three-dimensional point and the second confidence for a second three-dimensional point with their coordinates corresponding to each other. When the integrated confidence satisfies a certain condition, the determination unit 27 determines the first three-dimensional point or the second three-dimensional point to be a three-dimensional point on the object.

In the first embodiment, calibration has already been performed so that a coordinate system of the image-capturing unit 11 and a coordinate system of the measurement unit 13 match and coordinate systems of a plurality of images captured from a plurality of viewpoints by the image-capturing unit 11 match. Thus, the coordinate system of first three-dimensional points and that of second three-dimensional points match. The determination unit 27 may determine that coordinates of a first three-dimensional point and coordinates of a second three-dimensional point correspond to each other when the coordinates of the first and the second three-dimensional points have the same values, or have values within a certain range.

Supposing that the first confidence is C₁, and the second confidence is C₂, an integrated confidence C can be obtained by, for example, Equation (2) or quation (3).

C=ₛC₁+ₜC₂ (2)

C=ₛC₁C₂ (3)

In Equations (2) and (3), s represents weight of the first confidence C₁, and t represents weight of the second confidence C₂. Values of s and t may be, for example, s=t when C₁=C₂, or may be t=0 when C₁>C₂.

The integrated confidence satisfies a certain condition when, for example, the integrated confidence has a maximum value, or exceeds a threshold, but the embodiment is not limited to this.

The output unit 29 outputs coordinates of the three-dimensional point on the object determined by the determination unit 27.

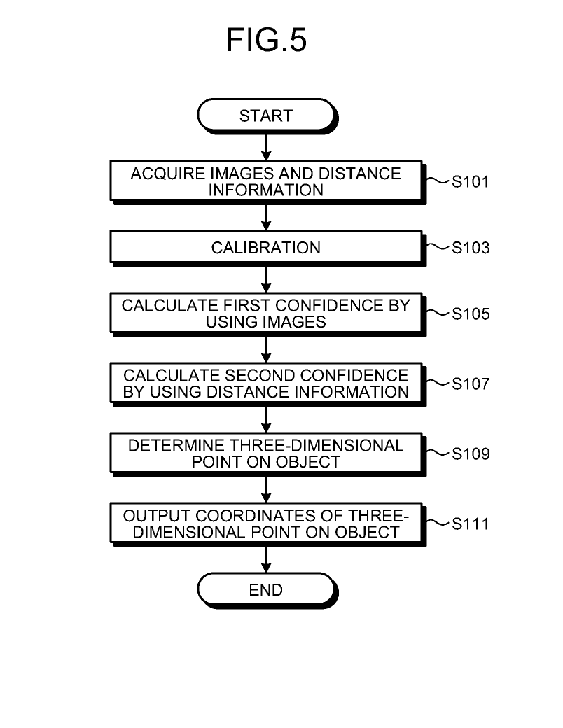

FIG. 5 is a flowchart illustrating an example of the procedure performed by the measurement device 10 according to the first embodiment.

First, the acquisition unit 21 acquires a plurality of images of an object captured from a plurality of viewpoints, and distance information indicating a measurement result of a distance from a measurement position to a measured point on the object (Step S101).

The acquisition unit 21 then performs calibration so that coordinate systems of the acquired images match (Step S103).

The first calculator 23 calculates, by using the images acquired by the acquisition unit 21, first confidence for each of a plurality of first three-dimensional points in three-dimensional space indicating likelihood that the first three-dimensional point is a point on the object (Step S105).

The second calculator 25 calculates, by using the distance information acquired by the acquisition unit 21, second confidence for each of a plurality of second three-dimensional points in the three-dimensional space indicating likelihood that the second three-dimensional point is a point on the object (Step S107).

The determination unit 27 determines a three-dimensional point on the object by using the first confidence calculated by the first calculator 23 and the second confidence calculated by the second calculator 25 (Step S109).

The output unit 29 outputs the coordinates of the three-dimensional point on the object determined by the determination unit 27 (Step S111).

In the first embodiment described above, a three-dimensional point on an object is determined on the basis of first confidence calculated by using a plurality of images of the object captured from a plurality of viewpoints, and second confidence calculated by using distance information indicating a measurement result of a distance from a measurement position to a measured point on the object.

As described above, the measurement device according to the first embodiment determines a three-dimensional point on an object by using the first confidence with its accuracy being dependent on the texture of the object, and the second confidence with its accuracy being independent from the texture of the object, so that the measurement device can eliminate an adverse effect on accuracy in three-dimensional measurement caused by the texture of the object, and can perform a more accurate three-dimensional measurement.

This enables the measurement device to perform an accurate measurement of an object at one time even when the object has texture in some regions and no texture in the other regions.

When the object has no texture (when the object has a single color), accuracy of measurement tends to decrease because the measurement device calculates the first confidence on the basis of pixel values of a plurality of images.

### Second Embodiment

In a second embodiment, an example is described in which the measurement device calculates the second confidence by also using a pixel value based on a measured point. The following mainly describes differences between the first and the second embodiments. The same names and reference signs are given to constituent elements of the second embodiment that have the same function as that of the first embodiment, and the explanation thereof is omitted.

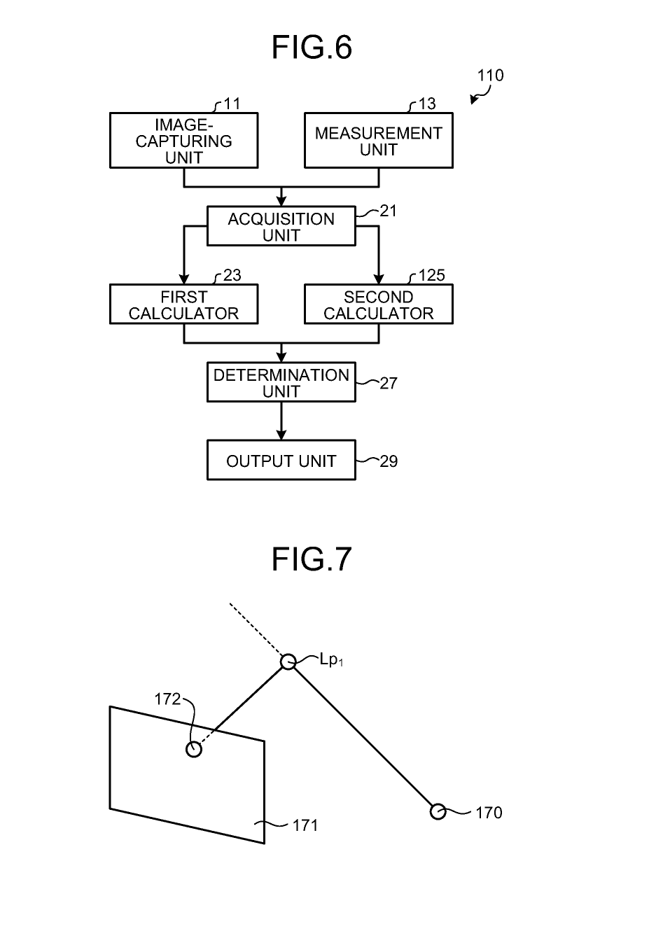

FIG. 6 is a configuration diagram illustrating an example of a measurement device 110 according to the second embodiment. As illustrated in FIG. 6, the measurement device 110 according to the second embodiment includes a second calculator 125 that is different from the second calculator 25 in the first embodiment.

The second calculator 125 calculates the second confidence by also using a plurality of images acquired by the acquisition unit 21. Specifically, the second calculator 125 projects a measured point onto an image captured by the image-capturing unit 11 from a viewpoint among a plurality of viewpoints from which the image-capturing unit 11 captures images. The viewpoint corresponds to a measurement position of the measured point. The second calculator 125 then calculates a pixel value of a projection point on the image. The second calculator 125 calculates the second confidence such that as the pixel value increases, the second confidence increases.

FIG. 7 is a diagram illustrating an example of a method for calculating the second confidence according to the second embodiment.

Suppose that the measurement unit 13 has measured an object from the center (center of the distance sensor) 170 of the measurement unit 13 that is a measurement position, and has acquired a measured point Lp₁.

The second calculator 125 sets a line passing through the center 170 of the distance sensor and the measured point Lp₁. Three-dimensional points on the line are represented by a variable X. When the second confidence of each of the three-dimensional points on the line is represented by F(X), F(X) is expressed by Equation (4) using a normal distribution, where Lₚ represents its mean, and σ represents its deviation.

$$F ( X ) = ab \frac{1}{\sqrt{2 π {σ}^{2}}} exp ( \frac{{( X - {L}_{p} )}^{2}}{2 {σ}^{2}} ) \qquad ( 4 )$$

In Equation (4), b represents a variable for adjusting the value of the second confidence, and is calculated from a pixel value based on the measured point Lp₁. For example, the second calculator 125 selects, from the time-series images acquired by the acquisition unit 21, an image 171 captured from a viewpoint corresponding to a measurement position of the measured point Lp₁, and projects the measured point Lp₁ onto the image 171 to obtain a projection point 172 on the image 171. The second calculator 125 then calculates b from the pixel value of the projection point 172. Supposing, for example, the pixel value of the projection point 172 is P₁, b can be P₁.

Consequently, the second confidence increases as the pixel value increases. Examples of the pixel value include, but are not limited to, a luminance value.

σ and a in Equation (4) are the same as those described in the first embodiment.

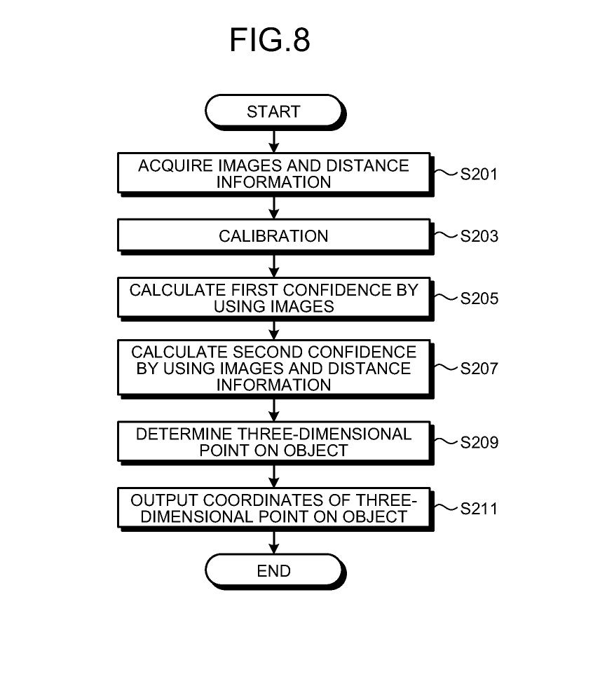

FIG. 8 is a flowchart illustrating an example of the procedure performed by the measurement device 110 according to the second embodiment.

Processing at Steps S201, S203, and S205 is the same as the processing at Steps S101, S103, and S105 in the flowchart illustrated in FIG. 5.

At Step S207, the second calculator 125 uses a plurality of images of an object and distance information acquired by the acquisition unit 21 to calculate the second confidence for each of a plurality of second three-dimensional points in three-dimensional space indicating likelihood that the second three-dimensional point is a point on the object (Step S207).

The following processing of Steps S209 and S211 is the same as the processing of Steps S109 and S111 in the flowchart illustrated in FIG. 5.

As described above, the measurement device according to the second embodiment calculates the second confidence by using a plurality of images of an object captured from a plurality of viewpoints, and distance information indicating a measurement result of a distance from a measurement position to a measured point on the object, so that the accuracy of the second confidence can be further improved, thereby improving the accuracy of the three-dimensional measurement.

First Modification

In the first and the second embodiments, the image-capturing unit 11 and the measurement unit 13 are attached to each other, and the measurer captures images of the object 50 with the image-capturing unit 11 and measures the object 50 with the measurement unit 13 while moving around the object 50. The description above is illustrative and not limiting. For example, a plurality of devices including the image-capturing unit and the measurement unit attached to each other may be disposed around the object 50.

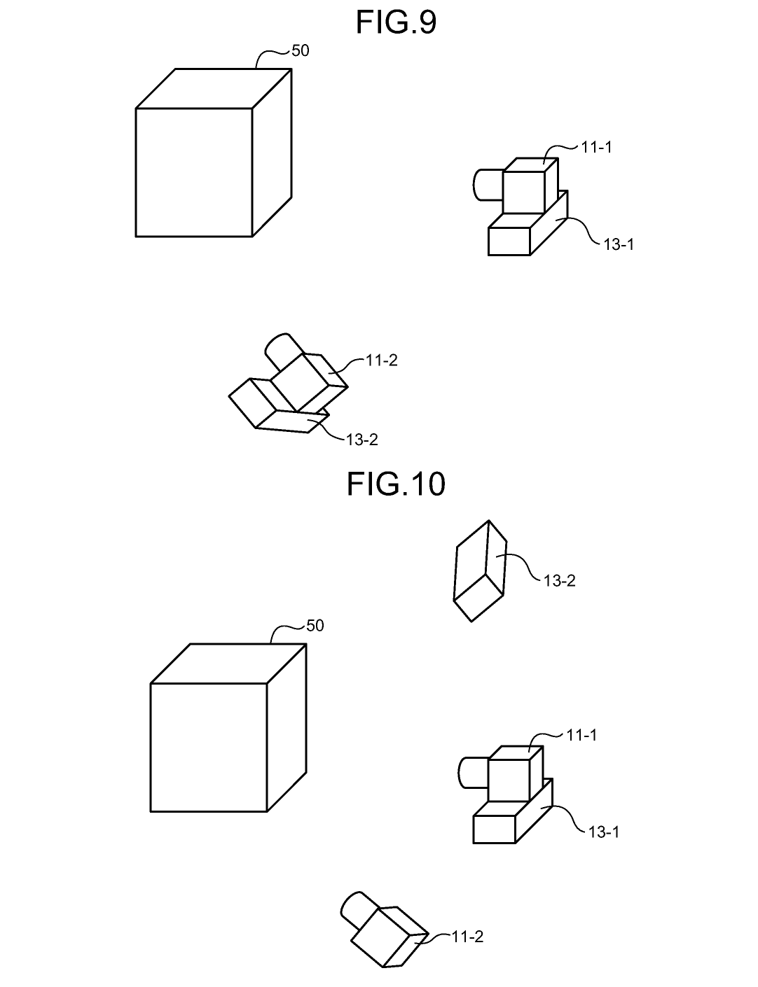

FIG. 9 is a diagram illustrating an example of an image-capturing and measurement method according to a first modification. In the example illustrated in FIG. 9, a device including an image-capturing unit 11-1 and a measurement unit 13-1 attached to each other and a device including an image-capturing unit 11-2 and a measurement unit 13-2 attached to each other are disposed around the object 50, and the measurer captures images and performs measurement by using the devices.

In the first modification, the same calibration as that of the first embodiment is performed so that a coordinate system of the image-capturing unit and that of the measurement unit match. Examples of calibration to match coordinate systems of images constituting the time-series images captured from a plurality of different viewpoints include a method described in Zhengyou Zhang, “A Flexible New Technique for Camera Calibration,” IEEE Transactions on Pattern Analysis and Machine Intelligence, volume 22, issue 11, pp. 1330-1334, 2000. In the method, calibration is performed by capturing a plainer checker pattern from all the viewpoints.

For example, a plurality of devices including the image-capturing unit and the measurement unit that are separated from each other may be disposed around the object 50.

FIG. 10 is a diagram illustrating another example of the image-capturing and measurement method according to the first modification. In the example illustrated in FIG. 10, the device including the image-capturing unit 11-1 and the measurement unit 13-1 that are attached to each other, a device including the image-capturing unit 11-2, and a device including the measurement unit 13-2 are disposed around the object 50, and the measurer captures images and performs measurement by using these devices.

With the image-capturing and measurement method according to the first modification, accuracy in measurement increases as the number of viewpoints increases from which images are captured.

Second Modification

In a second modification, a case is described in which the image-capturing unit is a compound-eye camera including a microlens array.

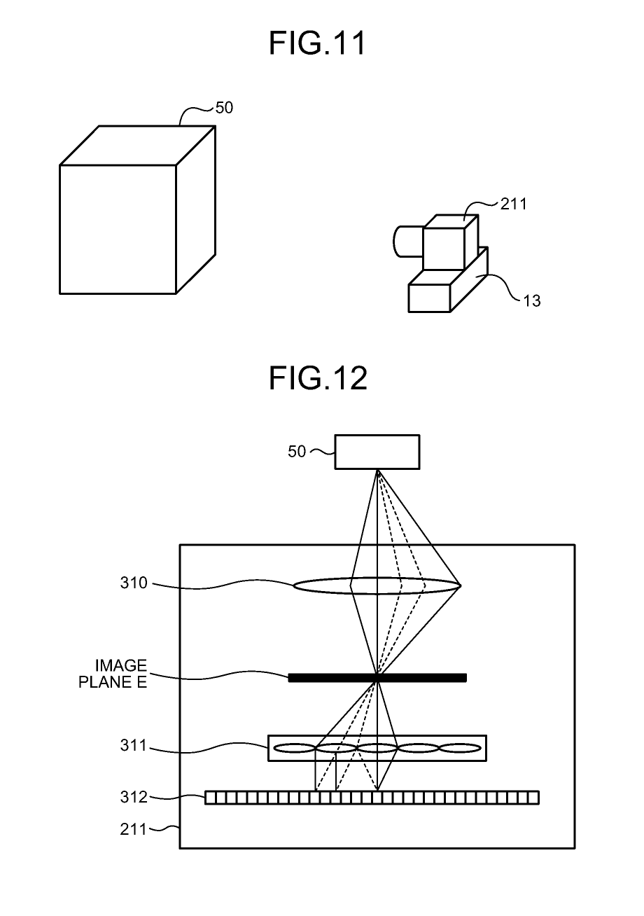

FIG. 11 is a diagram illustrating an example of an image-capturing and measurement method according to the second modification. In the example illustrated in FIG. 11, an image-capturing unit 211 and the measurement unit 13 are attached to each other, and the measurer captures images of the object 50 with the image-capturing unit 211 and measures the object 50 with the measurement unit 13 while moving around the object 50.

FIG. 12 is a configuration diagram illustrating an example of the image-capturing unit 211 according to the second modification. As illustrated in FIG. 12, the image-capturing unit 211 includes an image-capturing optical system including a main lens 310 that forms an image from light from the object 50, a microlens array 311 on which a plurality of microlenses are arranged, and an optical sensor 312.

In the example illustrated in FIG. 12, the main lens 310 is disposed such that an image-forming plane (image plane E) of the main lens 310 is positioned between the main lens 310 and the microlens array 311.

The image-capturing unit 211 also includes a sensor drive unit (not illustrated) that drives the optical sensor 312. The sensor drive unit is controlled in accordance with a control signal received from outside of the image-capturing unit 211.

The optical sensor 312 converts light forming an image on its light-receiving surface by the microlenses of the microlens array 311 into electrical signals, and outputs the signals. Examples of the optical sensor 312 include a charge coupled device (CCD) image sensor and a complementary metal oxide semiconductor (CMOS) image sensor. These image sensors are constituted of light-receiving elements each corresponding to a pixel that are disposed in matrix on the light-receiving surface. The light-receiving elements perform photoelectric conversion to convert light into electrical signals for pixels, and the electrical signals are output.

The image-capturing unit 211 receives incident light entering from a position on the main lens 310 to a position on the microlens array 311 with the optical sensor 312, and outputs image signals containing pixel signals for respective pixels. The image-capturing unit 211 having the above-described configuration is known as a light-field camera, or a plenoptic camera.

The image-capturing unit 211 can obtain a plurality of images captured from a plurality of viewpoints by taking just one capturing.

In the second modification, the same calibration as that of the first embodiment is performed to match a coordinate system of the image-capturing unit and that of the measurement unit. When calibration is performed to match coordinate systems of a plurality of images captured from a plurality of different viewpoints, an optical system defined at the time of manufacturing the microlens array is used.

Hardware Configuration

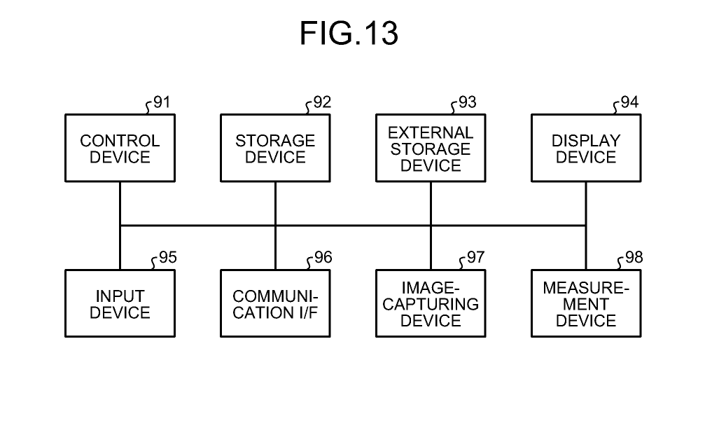

FIG. 13 is a block diagram illustrating an example of a hardware configuration of the measurement device according to the first and the second embodiments and the first and the second modifications. As illustrated in FIG. 13, the measurement device according to the embodiments and modifications above includes a control device 91 such as a central processing unit (CPU), a storage device 92 such as a read only memory (ROM) and a random access memory (RAM), an external storage device 93 such as a hard disk drive (HDD) and a solid state drive (SSD), a display device 94 such as a display, an input device 95 such as a mouse and a keyboard, a communication I/F 96, an image-capturing device 97 such as a visible camera, and a measurement device 98 such as a laser sensor, and can be implemented by a hardware configuration using a typical computer.

A computer program executed in the measurement device according to the embodiments and modifications above is embedded and provided in a ROM, for example. The computer program executed in the measurement device according to the embodiments and modifications above is recorded and provided, as a computer program product, in a computer-readable recording medium such as a compact disc read only memory (CD-ROM), a compact disc recordable (CD-R), a memory card, a digital versatile disc (DVD), and a flexible disk (FD) as an installable or executable file. The computer program executed in the measurement device according to the embodiments and modifications above may be stored in a computer connected to a network such as the Internet and provided by being downloaded via the network.

The computer program executed in the measurement device according to the embodiments and modifications above has a module configuration that implements the units described above on the computer. As hardware, the control device 91 loads the computer program from the external storage device 93 on the storage device 92 and executes it, thereby implementing the above-described units on the computer.

According to the embodiments and the modification described above, accuracy in three-dimensional measurement can be improved.

In the embodiment above, for example, the steps of the flowcharts may be performed in a different order, a plurality of steps may be performed simultaneously, or the steps may be performed in a different order for each round of the process, as long as these changes are not inconsistent with the nature of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement device comprising:
an acquisition unit configured to acquire a plurality of images of an object from a plurality of viewpoints, and distance information indicating a measurement result of a distance from a measurement position to a measured point on the object;
a first calculator configured to calculate, by using the images, first confidence for each of a plurality of first three-dimensional points in three-dimensional space, the first confidence indicating likelihood that the first three-dimensional point is a point on the object;
a second calculator configured to calculate, by using the distance information, second confidence for each of a plurality of second three-dimensional points in the three-dimensional space, the second confidence indicating likelihood that the second three-dimensional point is a point on the object; and
a determination unit configured to determine a three-dimensional point on the object by using the first confidence and the second confidence.

2. The device according to claim 1, wherein the second calculator is configured to calculate the second confidence by also using the images.

3. The device according to claim 1, wherein
the distance information includes the distance; and
the second calculator is configured to calculate the measured point based on the distance, set the second three-dimensional points on a line passing through the measured point and the measurement position, and calculate the second confidence for each of the second three-dimensional points.

4. The device according to claim 3, wherein the second calculator is configured to calculate the second confidence for a second three-dimensional point such that as a distance between the measured point and the second three-dimensional point decreases, the second confidence for the second three-dimensional point increases.

5. The device according to claim 4, wherein the second calculator is configured to calculate the second confidence such that as accuracy of measurement of a measurement unit measuring the distance increases and as a distance to the measured point decreases, a difference in the second confidence between second three-dimensional points adjacent to each other increases.

6. The device according to claim 5, wherein the distance information further includes the accuracy of measurement.

7. The device according to claim 5, wherein the second confidence for the second three-dimensional points represents a normal distribution with the measured point being center.

8. The device according to claim 4, wherein
the distance information further includes reflection intensity of light used to measure the distance; and
the second calculator is configured to calculate the second confidence such that as the reflection intensity increases, the second confidence increases.

9. The device according to claim 4, wherein the second calculator is configured to project the measured point onto an image captured from a viewpoint among the viewpoints, the viewpoint corresponding to the measurement position, calculate a pixel value of a projection point on the image, and calculate the second confidence such that as the pixel value increases, the second confidence increases.

10. The device according to claim 1, wherein the determination unit is configured to calculate an integrated confidence obtained by adding or multiplying the first confidence for a first three-dimensional point and the second confidence for a second three-dimensional point with coordinates of the first three-dimensional point and the second three-dimensional point corresponding to each other, and determine the first three-dimensional point or the second three-dimensional point to be a three-dimensional point on the object when the integrated confidence satisfies a certain condition.

11. The device according to claim 10, wherein the integrated confidence satisfies the certain condition when the integrated confidence has a maximum value or exceeds a threshold.

12. The device according to claim 1, wherein the first calculator is configured to calculate the first confidence by using multiple-baseline stereo.

13. The device according to claim 12, wherein the first calculator is configured to calculate the first three-dimensional points by using a first two-dimensional point on a reference image among the images, project the first three-dimensional points onto an image among the images other than the reference image to calculate a plurality of second two-dimensional points on the image, and calculate the first confidence for each of the first three-dimensional points based on similarity between a pixel value of the first two-dimensional point and a pixel value of each of the second two-dimensional points.

14. The device according to claim 1, wherein the images are captured by a compound-eye camera including a microlens array.

15. A measurement method comprising:
acquiring a plurality of images of an object from a plurality of viewpoints, and distance information indicating a measurement result of a distance from a measurement position to a measured point on the object;
calculating, by using the images, first confidence for each of a plurality of first three-dimensional points in three-dimensional space, the first confidence indicating likelihood that the first three-dimensional point is a point on the object;
calculating, by using the distance information, second confidence for each of a plurality of second three-dimensional points in the three-dimensional space, the second confidence indicating likelihood that the second three-dimensional point is a point on the object; and
determining a three-dimensional point on the object by using the first confidence and the second confidence.

16. A computer program product comprising a computer-readable medium containing a program executed by a computer, the program causing the computer to execute:
acquiring a plurality of images of an object from a plurality of viewpoints, and distance information indicating a measurement result of a distance from a measurement position to a measured point on the object;
calculating, by using the images, first confidence for each of a plurality of first three-dimensional points in three-dimensional space, the first confidence indicating likelihood that the first three-dimensional point is a point on the object;
calculating, by using the distance information, second confidence for each of a plurality of second three-dimensional points in the three-dimensional space, the second confidence indicating likelihood that the second three-dimensional point is a point on the object; and
determining a three-dimensional point on the object by using the first confidence and the second confidence.
